(19) United States
(12) Patent Application Publication
(10) Pub. No.: US 2015/0006874 A1
(43) Pub. Date: Jan. 1, 2015

(54) SYSTEM AND METHOD FOR MANAGING DATA USED FOR ACTIVATION OF OPERATING SYSTEMS

(71) Applicant: FUJITSU LIMITED, Kawasaki-shi (JP)

(72) Inventor: Tomonori FUJIWARA, Yamato (JP)

(73) Assignee: FUJITSU LIMITED, Kawasaki-shi (JP)

(21) Appl. No.: 14/286,238

(22) Filed: May 23, 2014

(30) Foreign Application Priority Data
Jun. 26, 2013 (JP) 2013-133692

(51) Int. Cl. G06F 9/44

(52) U.S. Cl. CPC G06F 9/4416
USPC 713/2

(57) ABSTRACT

A system includes first and second nodes and a management device managing the first and second nodes. The first node manages data used for activation of an operating system. The second node acquires, from the first node via a network, the data used for activation of the operating system, and activates the operating system. The management device initiates activation for the first and second nodes; acquires, from the first node, status data indicating a status of the first node; and transmits the status data to the second node upon receiving a status request requesting the status data from the second node. The second node acquires, from the first node, the data used for activation of the operating system when the status data received from the management device indicates that activation of the operating system for the first node has been completed, and activates the operating system for the second node.

### CROSS-REFERENCE TO RELATED APPLICATION

This application is based upon and claims the benefit of priority of the prior Japanese Patent Application No. 2013-133692, filed on Jun. 26, 2013, the entire contents of which are incorporated herein by reference.

### FIELD

The embodiments discussed herein are related to system and method for managing data used for activation of operating systems.

### BACKGROUND

In recent years, servers known as multi-node servers have come to be used in data centers. The nodes used in multi-node servers are able to be integrated to a higher degree than the rack-mounted servers that are conventionally used. Therefore, by using multi-node servers, it is possible to improve the processing capacity per unit space in a data center.

In order to save space and so forth, some nodes from among the nodes included in a multi-node server may not have a storage device (a hard disk drive (HDD) for example) in which data (operating system (OS) images for example) used for OS activation is stored. These kinds of nodes (hereafter referred to as network boot nodes) acquire, via a network, data used for OS activation from a node (hereafter referred to as a disk boot node) that has a storage device in which the data used for OS activation is stored.

The following technology is known in relation to shortening the activation time of information processing systems that include disk boot nodes and network boot nodes. Specifically, the booting of OSs in nodes included in an information processing system is completed by sequentially copying OS data stored in the main storage device of a node in which the booting of an OS has been completed, to the main storage devices of the other nodes.

Japanese Laid-open Patent Publication No. 6-295289 is an example of this technology.

### SUMMARY

According to an aspect of the invention, a system includes first and second nodes and a management device for managing the first and second nodes. The first node is configured to manage data used for activation of an operating system. The second node is configured to acquire, from the first node via a network, the data used for activation of the operating system, and to activate the operating system. The management device includes first, second, and third processing units. The first processing unit initiates activation for the first and second nodes. The second processing unit acquires, from the first node, status data indicating a status of the first node. The third processing unit, upon receiving a status request that requests the status data from the second node, transmits the status data to the second node. The second node includes a fourth processing unit configured to acquire from the first node data used for activation of the operating system when the status data received from the management device indicates that activation of the operating system for the first node has been completed, and to activate the operating system for the second node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system, according to an embodiment;

FIG. 2 is a diagram illustrating an example of a hardware configuration of a service processor, according to an embodiment;

FIG. 3 is a diagram illustrating an example of a hardware configuration of a node, according to an embodiment;

FIG. 4 is a diagram illustrating an example of a functional configuration of a service processor, according to an embodiment;

FIG. 5 is a diagram illustrating an example of a functional configuration of a node, according to an embodiment;

FIG. 6 is a diagram illustrating an example of data stored in a status data storage unit, according to an embodiment;

FIG. 7 is a diagram illustrating an example of an operational flowchart for processing executed by a service processor, according to an embodiment;

FIG. 8 is a diagram illustrating an example of an operational flowchart for processing executed by a disk boot node, according to an embodiment;

FIG. 9 is a diagram illustrating an example of an operational flowchart for processing executed by a network boot node, according to an embodiment;

FIG. 10 is a diagram illustrating an example of an activation time for a system when a method of an embodiment is not used;

FIG. 11 is a diagram illustrating an example of an activation time for a system, according to an embodiment;

FIG. 12 is a schematic diagram illustrating an example of a fault occurrence, according to an embodiment;

FIG. 13 is a diagram illustrating an example of a system including two or more disk boot nodes, according to an embodiment;

FIG. 14 is a diagram illustrating an example of an occurrence of a fault in a system including two or more disk boot nodes, according to an embodiment;

FIG. 15 is a diagram illustrating an example of an operational flowchart for processing executed by a service processor, according to an embodiment; and

FIG. 16 is a diagram illustrating an example of an operational flowchart for processing executed by a network boot node, according to an embodiment.

### DESCRIPTION OF EMBODIMENTS

When the above mentioned technology is used, it is sometimes not possible to sufficiently shorten the activation time of the information processing system. According to this technology, the activation time increases as the number of nodes increases, and this technology therefore has a problem in that activation may take a considerable length of time depending on the scale of the information processing system.

### Embodiment 1

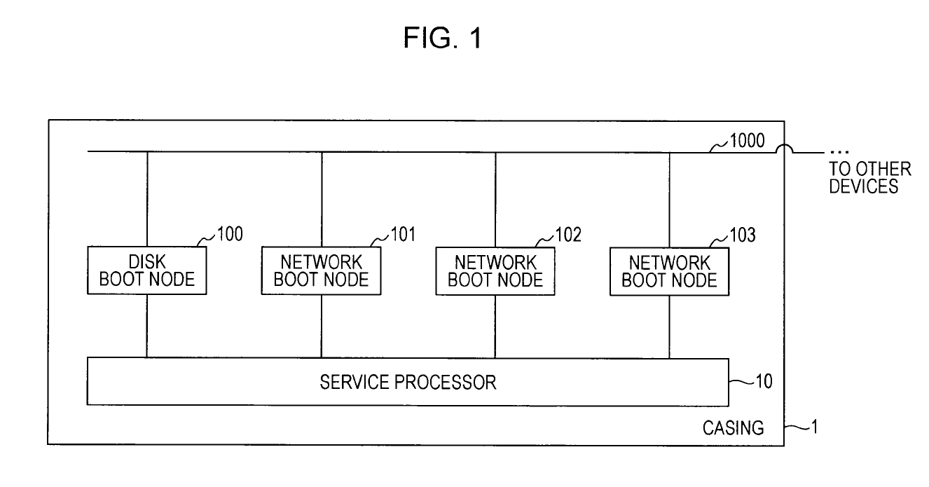

FIG. 1 is a diagram illustrating an example of a system, according to an embodiment. A disk boot node 100, network boot nodes 101 to 103, and a service processor 10 are included in a casing 1 for housing a plurality of nodes. The disk boot node 100 and the network boot nodes 101 to 103 are connected via a network 1000 which is a network performing communication among nodes. Furthermore, the service processor 10 is connected to the disk boot node 100 and the network boot nodes 101 to 103, and controls the activating and stopping of these nodes and also monitors errors and so forth. Although there are three network boot nodes in FIG. 1, there is no restriction to the number of network boot nodes.

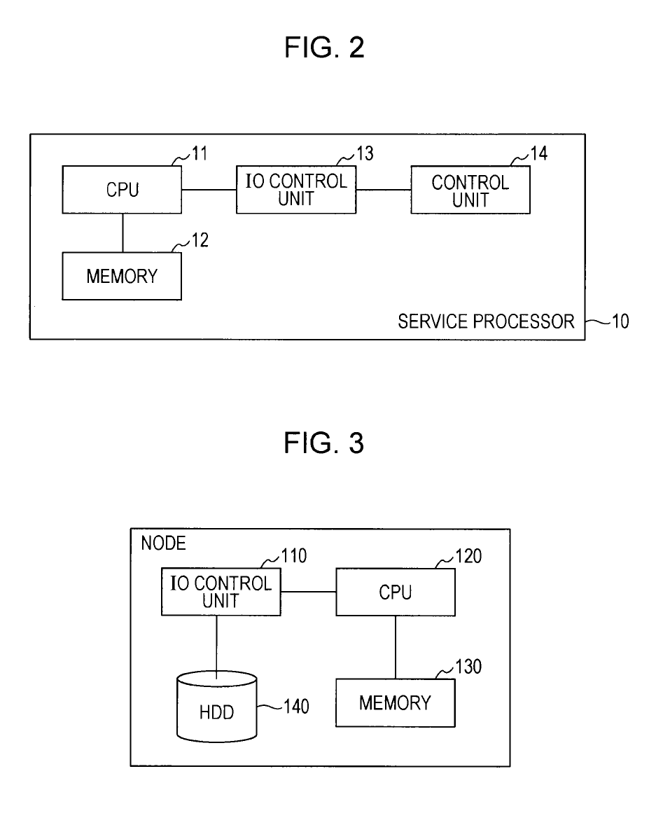

FIG. 2 is a diagram illustrating an example of a hardware configuration of a service processor, according to an embodiment. In the example of FIG. 2, the service processor 10 includes: a CPU 11; a memory 12; an IO (input output) control unit 13 that controls the input and output of data between the CPU 11 and a control unit 14; and the control unit 14, which is an interface for communicating with nodes (in the embodiment, the disk boot node 100 and the network boot nodes 101 to 103) and so forth. The CPU 11 is connected to the memory 12 and the IO control unit 13. The IO control unit 13 is connected to the control unit 14.

FIG. 3 is a diagram illustrating an example of a hardware configuration of a node, according to an embodiment. In the example of FIG. 3, the node includes: an IO control unit 110 that is an interface for communicating with the service processor 10 and so forth; a CPU 120; a memory 130; and a hard disk drive (HDD) 140. The network boot nodes 101 to 103 may not include a HDD 140. System data is stored in the HDD 140 of the disk boot node 100. The system data includes data used for OS activation (OS images for example) and network server programs (dynamic host configuration protocol (DHCP) and trivial file transfer protocol (TFTP) programs for example). Moreover, the HDD 140 may be provided outside of the node instead of inside the node. Furthermore, another storage device (a solid-state drive (SSD) for example) may be used instead of a HDD.

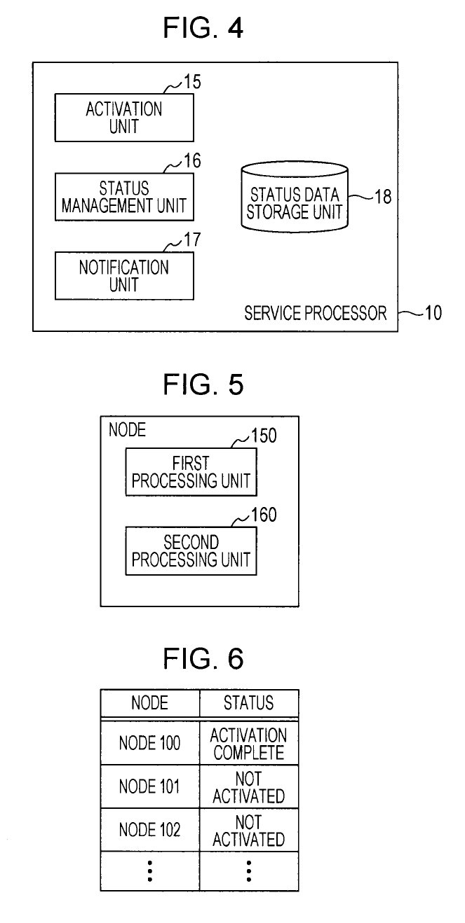

FIG. 4 is a diagram illustrating an example of a functional configuration of a service processor, according to an embodiment. In the example of FIG. 4, the service processor 10 includes an activation unit 15, a status management unit 16, a notification unit 17, and a status data storage unit 18. Programs (firmware for example) for realizing the activation unit 15, the status management unit 16, and the notification unit 17 are stored in the memory 12 for example, and the activation unit 15, the status management unit 16, and the notification unit 17 are realized by the programs being executed by the CPU 11. A region for the status data storage unit 18 is ensured in the memory 12 for example.

FIG. 5 is a diagram illustrating an example of a functional configuration of a node, according to an embodiment. In the example of FIG. 5, the node includes a first processing unit 150 and a second processing unit 160. Programs (firmware for example) for realizing the first processing unit 150 and the second processing unit 160 are stored in the memory 130 for example, and the first processing unit 150 and the second processing unit 160 are realized by the programs being executed by the CPU 120.

FIG. 6 is a diagram illustrating an example of data stored in a status data storage unit, according to an embodiment. In the example of FIG. 6, identification information of nodes, and data indicating statuses (for example, whether or not activation has been completed and so forth) are stored.

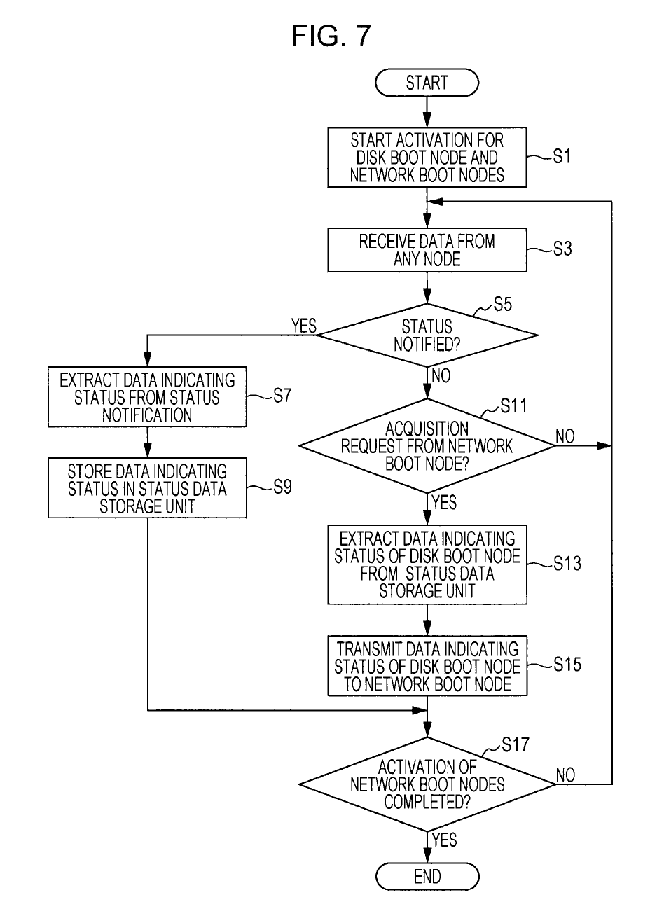

Next, the operation of the system depicted in FIG. 1 is described using FIGS. 7 to 9. First, processing executed by the service processor 10 is described using FIG. 7.

In a state in which none of the nodes in the casing 1 are activated, the activation unit 15 in the service processor 10 initiates (turns on a power source for example) activation for the disk boot node 100 and the network boot nodes 101 to 103 (FIG. 7: step S1).

The service processor 10 waits until data is received from any of the nodes. The status management unit 16 in the service processor 10 then receives data from any of the nodes (step S3).

The status management unit 16 determines whether the data received in step S3 is a status notification (step S5). A status notification includes data indicating the status of a node (for example, whether or not activation has been completed and so forth), and is transmitted to the service processor 10 by the disk boot node 100 and the network boot nodes 101 to 103. The transmission is performed periodically for example.

When the data received is a status notification (step S5: “yes” route), the status management unit 16 extracts the data indicating the status from the status notification (step S7), and stores the data indicating the status in the status data storage unit 18 (step S9). Processing then moves to the processing of step S17.

On the other hand, when the data received is not a status notification (step S5: “no” route), the status management unit 16 determines whether the data received is an acquisition request received from a network boot node (step S11). An acquisition request requests the acquisition of data indicating the status of the disk boot node 100, and is transmitted to the service processor 10 by a network boot node.

When the data received is not an acquisition request from a network boot node (step S11: “no” route), the data received in step S3 is data that is not directly related to the processing of the embodiment. Therefore, the status management unit 16 performs processing for the data received, and returns to the processing of step S3.

On the other hand, when the data received is an acquisition request from a network boot node (step S11: “yes” route), the status management unit 16 extracts data indicating the status of the disk boot node 100 from the status data storage unit 18 (step S13). The status management unit 16 then instructs the notification unit 17 to transmit the data indicating the status of the disk boot node 100. In response to this, the notification unit 17 transmits the data indicating the status of the disk boot node 100 to the network boot node that is the transmission source of the data received in step S3 (step S15).

The status management unit 16 specifies data indicating statuses stored in the status data storage unit 18, with respect to the network boot nodes 101 to 103, and thereby determines whether the activation of the network boot nodes 101 to 103 has been completed (step S17).

When the activation of the network boot nodes 101 to 103 has not been completed (step S17: “no” route), processing returns to the processing of step S3. On the other hand, when the activation of the network boot nodes 101 to 103 has been completed (step S17: “yes” route), processing is finished.

When processing such as the above is executed, it becomes possible for the disk boot node 100 and the network boot nodes 101 to 103 to perform, at the same time, processing to be executed prior to activating an OS, and it therefore becomes possible to shorten the time desired for the activation of the system. Furthermore, the network boot nodes 101 to 103 are able to reliably confirm the status of the disk boot node 100 by way of the service processor 10, and it therefore becomes possible to quickly activate an OS after the activation of the OS for the disk boot node 100 has been completed.

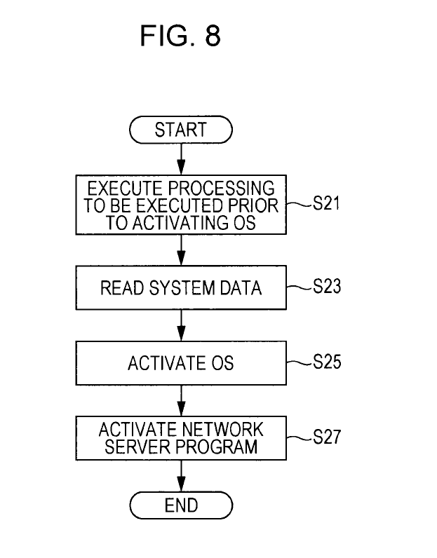

Next, processing executed by the disk boot node 100 is described using FIG. 8.

When activation is initiated by the service processor 10, the first processing unit 150 in the disk boot node 100 executes processing to be executed prior to activating an OS (FIG. 8: step S21). For example, the initialization and diagnosis (power-on-self-test (POST) for example) of hardware are included in the processing to be executed prior to activating an OS.

The second processing unit 160 reads system data from the HDD 140 (step S23), and activates an OS using the data used for OS activation included in the system data that has been read (step S25). The second processing unit 160 then activates a network server program included in the system data read in step S23 (step S27). The processing then finishes.

When processing such as the above is executed, it becomes possible for the disk boot node 100 to operate as usual.

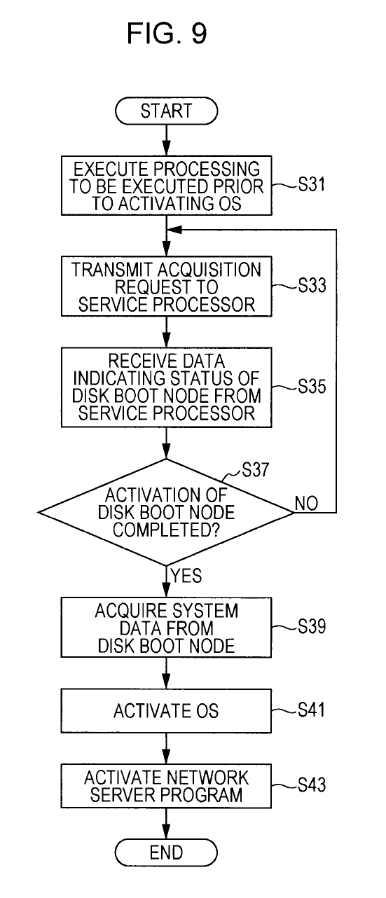

Next, processing executed by the network boot nodes 101 to 103 is described using FIG. 9. In order to simplify the description, here the network boot node 101 is described as an example.

First, when activation is initiated by the service processor 10, the first processing unit 150 in the network boot node 101 executes processing to be executed prior to activating an OS (FIG. 9: step S31). For example, the initialization and diagnosis (power-on-self-test (POST) for example) of hardware are included in the processing to be executed prior to activating an OS.

The second processing unit 160 transmits, to the service processor 10, an acquisition request that requests the acquisition of data indicating the status of the disk boot node 100 (step S33). The second processing unit 160 then receives, from the service processor 10, data indicating the status of the disk boot node 100, as a response to the acquisition request (step S35).

The second processing unit 160 determines, by using the data indicating the status of the disk boot node 100, whether the activation of the disk boot node 100 has been completed (step S37).

When the activation of the disk boot node 100 has not been completed (step S37: “no” route), since the network boot node 101 is not able to activate an OS, processing returns to the processing of step S33. On the other hand, when the activation of the disk boot node 100 has been completed (step S37: “yes” route), the second processing unit 160 acquires system data from the disk boot node 100 (step S39).

The second processing unit 160 activates an OS using the data used for OS activation included in the system data acquired in step S39 (step S41). The second processing unit 160 then activates a network server program included in the system data acquired in step S39 (step S43). The processing then finishes.

When processing such as the above is executed, it becomes possible for the network boot nodes 101 to 103 to perform processing to be executed prior to OS activation, in parallel with the processing of the disk boot node 100, and it therefore becomes possible to shorten the time desired for the activation of the system.

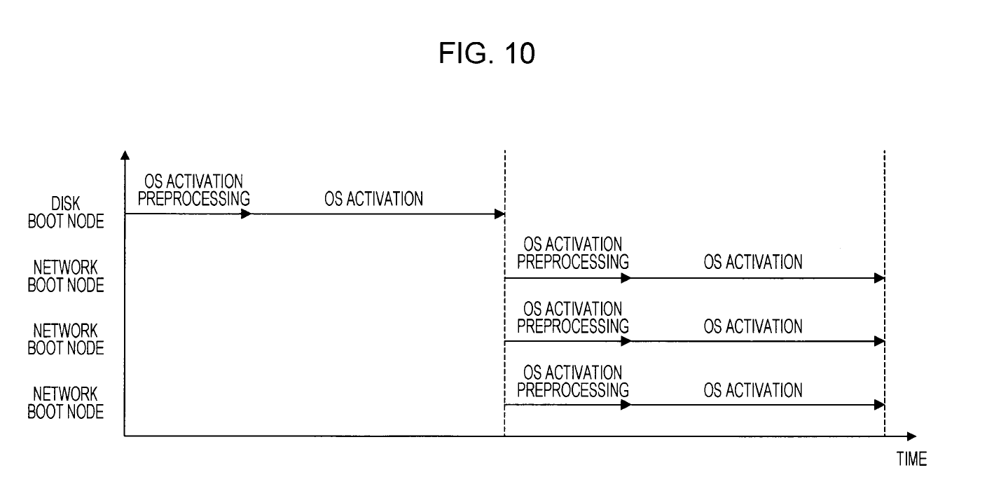

Next, the effects of the embodiment are described in detail using FIGS. 10 to 14.

FIG. 10 depicts the activation time for a system when the method of the embodiment is not used. In FIG. 10, the horizontal axis represents time and indicates, with respect to each of the disk boot node 100 and the network boot nodes 101 to 103, the time from activation being initiated by the service processor 10 to OS activation being completed.

In this method, the service processor 10 first initiates activation for the disk boot node 100. To be specific, OS activation preprocessing (for example, POST and software loading and initialization) and OS activation (here, processing to load OS data into a memory is also included) are executed in the disk boot node 100.

When the activation of the OS for the disk boot node 100 has been completed, the activation of the network boot nodes 101 to 103 is initiated by the service processor 10. OS activation preprocessing and OS activation are also executed in the network boot nodes 101 to 103 as in the disk boot node 100.

When used, the activation method depicted in FIG. 10 takes approximately twice the length of time that is desired for the activation of one node.

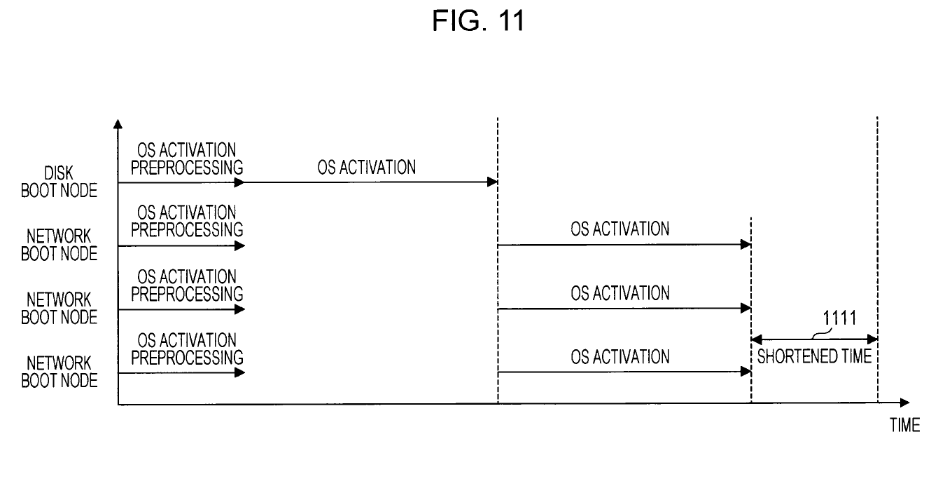

FIG. 11 is a diagram illustrating an example of an activation time for a system when the method of the embodiment is used, according to an embodiment. In FIG. 11, as in FIG. 10, the horizontal axis represents time and indicates, with respect to each of the disk boot node 100 and the network boot nodes 101 to 103, the time from activation being initiated by the service processor 10 to OS activation being completed.

In the embodiment, the service processor 10 initiates the activation of the disk boot node 100 and the network boot nodes 101 to 103 at the same time. This is because it is possible for the network boot nodes 101 to 103 to perform OS activation preprocessing even if the activation of the OS for the disk boot node 100 has not been completed. After the OS activation preprocessing has been completed, the network boot nodes 101 to 103 are not able to acquire system data from the disk boot node 100 until the activation of the OS for the disk boot node 100 has been completed, and it is therefore not possible to perform OS activation. When the activation of the OS for the disk boot node 100 has been completed, the network boot nodes 101 to 103 are able to acquire system data from the disk boot node 100, and OS activation is therefore initiated.

In this way, compared to the method depicted in FIG. 10, it becomes possible to shorten the activation time of the system by an amount of time equal to the length of the arrow mark 1111.

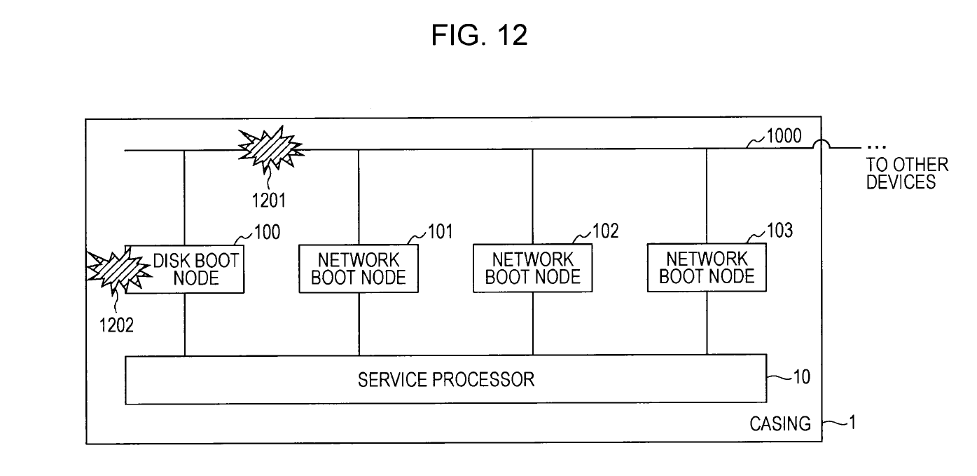

Furthermore, in the embodiment, because the network boot nodes 101 to 103 confirm the status of the disk boot node 100 by way of the service processor 10, it becomes possible to easily distinguish between a fault in the network and a fault in the disk boot node 100. This is described using FIG. 12.

When a fault 1201 has occurred in the inter-node network 1000 for example, the network boot nodes 101 to 103 are able to acquire system data from the disk boot node 100 as usual, and activate OSs. This is because the network boot nodes 101 to 103 perform confirmation via the service processor 10 without using the inter-node network 1000 when confirming the status of the disk boot node 100. Consequently, when the network boot nodes 101 to 103 are able to perform activation as usual, it is understood that the fault has occurred in the inter-node network 1000.

Furthermore, when a fault 1202 has occurred in the disk boot node 100, the disk boot node 100 is not able to complete activation. Therefore, the OSs of the network boot nodes 101 to 103 are also not able to complete activation. Consequently, if the OSs of the network boot nodes 101 to 103 do not complete activation, it is understood that the fault has occurred in the disk boot node 100.

In contrast to this, if the status of the disk boot node 100 is confirmed using the inter-node network 1000, the network boot nodes 101 to 103 are not able to confirm whether the activation of the disk boot node 100 has been completed regardless of where the fault has occurred. Therefore, regardless of where the fault has occurred, the network boot nodes 101 to 103 are not able to activate OSs, and it is therefore not possible to specify the fault occurrence point. Furthermore, if a fault 1202 has occurred in the disk boot node 100 and there is no fault 1201 in the inter-node network 1000, this results in the network boot nodes 101 to 103 confirming the status of the disk boot node 100 numerous times via the inter-node network 1000, and unnecessary communication occurs.

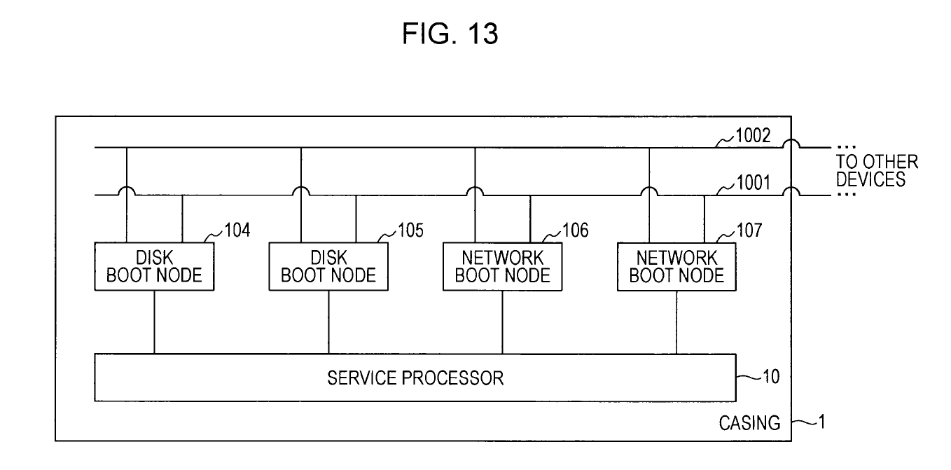

Moreover, although an example in which the system has one disk boot node has been given above, as depicted in FIG. 13 for example, the system may have two or more disk boot nodes. In the example of FIG. 13, the casing 1 includes disk boot nodes 104 and 105, network boot nodes 106 and 107, and a service processor 10. The service processor 10 is connected to the disk boot nodes 104 and 105 and to the network boot nodes 106 and 107. Furthermore, the disk boot nodes 104 and 105 and the network boot nodes 106 and 107 are connected via networks 1001 and 1002, which are networks that perform communication among nodes.

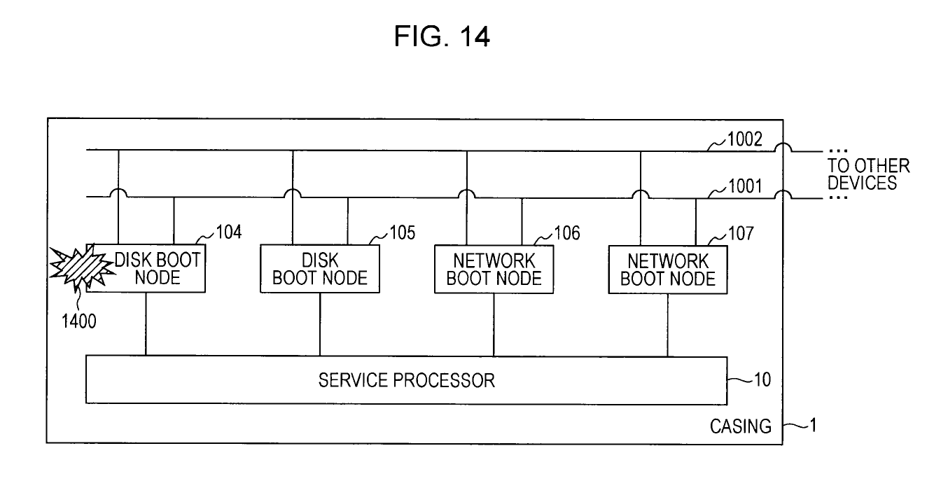

The situation where a fault 1400 has occurred in the disk boot node 104 in the system depicted in FIG. 13 is described using FIG. 14. In this situation, when the method of the embodiment is employed, the network boot nodes 106 and 107 are able to recognize by way of the service processor 10 that the fault 1400 has occurred in the disk boot node 104.

Furthermore, the network boot nodes 106 and 107 are able to acquire system data from the disk boot node 105 in which an error has not occurred, and initiate a network boot. Consequently, because there is no unnecessary communication processing and network load and so forth, a decline in the processing performance of the system is avoided.

In contrast to this, if the statuses of the disk boot nodes 104 and 105 are confirmed via the inter-node networks 1001 and 1002 rather than via the service processor 10, as mentioned above, it is not possible to specify where a fault has occurred. This results in the network boot nodes 106 and 107 performing communication for confirming the statuses of the disk boot nodes 104 and 105 with both of the networks 1001 and 1002. Furthermore, the network boot nodes 106 and 107 perform unnecessary processing such as processing to wait for a response from the disk boot nodes 104 and 105 and so forth. In addition, an unnecessary communication load occurs in the networks 1001 and 1002.

### Embodiment 2

Next, a second embodiment is described. In the first embodiment, the status of the disk boot node 100 is confirmed by transmission of an acquisition request to the service processor 10 by a network boot node that has completed the processing to be executed prior to OS activation. In contrast to this, in the second embodiment, when the service processor 10 has confirmed that activation of the disk boot node 100 has been completed and that the processing to be executed prior to OS activation has been completed in a network boot node, an OS activation request is transmitted to the network boot node. The network boot node that has completed the processing to be executed prior to OS activation initiates OS activation when the OS activation request is received.

First, the processing executed by the service processor 10 in the second embodiment is described.

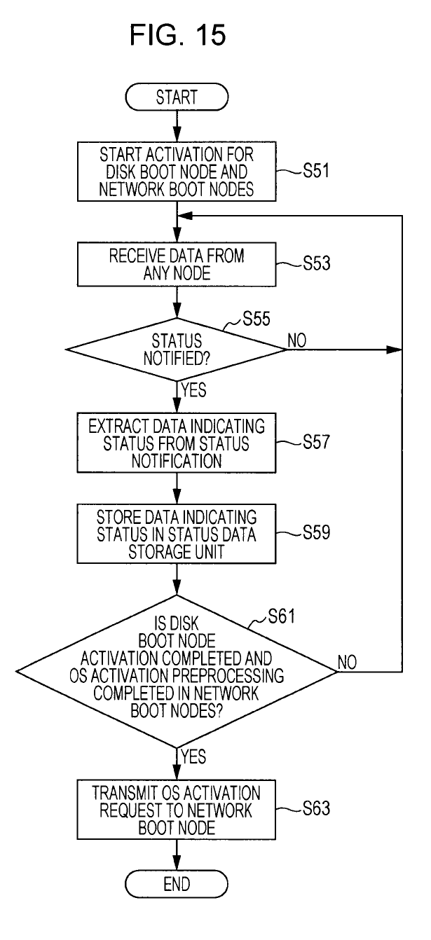

In a state in which none of the nodes in the casing 1 are activated, the activation unit 15 in the service processor 10 initiates (turns on a power source for example) activation for the disk boot node 100 and the network boot nodes 101 to 103 (FIG. 15: step S51).

The service processor 10 waits until data is received from any of the nodes. The status management unit 16 in the service processor 10 then receives data from any of the nodes (step S53).

The status management unit 16 determines whether the data received in step S53 is a status notification (step S55).

When the data received is not a status notification (step S55: “no” route), the data received in step S53 is data that is not directly related to the processing of the embodiment. Therefore, the status management unit 16 performs processing for the data received, and returns to the processing of step S53.

On the other hand, when the data received is a status notification (step S55: “yes” route), the status management unit 16 extracts data indicating a status from the status notification (step S57), and stores the data indicating the status in the status data storage unit 18 (step S59).

The status management unit 16 specifies data indicating statuses in the status data storage unit 18, with respect to the disk boot node 100 and the network boot nodes 101 to 103, and thereby determines whether the activation of the disk boot node 100 has been completed and processing to be executed prior to OS activation has been completed in the network boot nodes 101 to 103 (step S61).

When the activation of the disk boot node 100 has not been completed or the processing to be executed prior to OS activation has not been completed in the network boot nodes 101 to 103 (step S61: “no” route), since the OSs of the network boot nodes 101 to 103 are not able to be activated, processing returns to the processing of step S53.

On the other hand, when the activation of the disk boot node 100 has been completed and the processing to be executed prior to OS activation has been completed in the network boot nodes 101 to 103 (step S61: “yes” route), the status management unit 16 extracts data indicating the status of the disk boot node 100 from the status data storage unit 18. The status management unit 16 then instructs the notification unit 17 to transmit an OS activation request including the data indicating the status of the disk boot node 100. In response to this, the notification unit 17 transmits the data indicating the status of the disk boot node 100 to the network boot nodes that are the transmission sources of the data received in step S53 (step S63). The processing then finishes.

When processing such as the above is executed, it becomes possible for the disk boot node 100 and the network boot nodes 101 to 103 to perform, at the same time, processing to be executed prior to activating an OS, and it therefore becomes possible to shorten the time desired for the activation of the system. Furthermore, the network boot nodes 101 to 103 are able to be notified from the service processor 10 that the activation of the disk boot node 100 has been completed, and it therefore becomes possible to quickly activate OSs after the activation of the OS for the disk boot node 100 has been completed.

Next, processing executed by the network boot nodes 101 to 103 in the second embodiment is described. In order to simplify the description, here the network boot node 101 is described as an example.

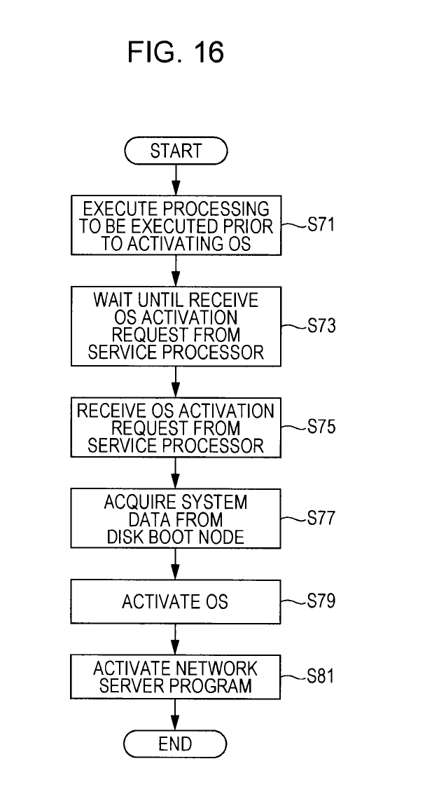

First, when activation is initiated by the service processor 10, the first processing unit 150 in the network boot node 101 executes processing to be executed prior to activating an OS (FIG. 16: step S71). The processing to be executed prior to activating an OS is, for example, the initialization and diagnosis (power-on-self-test (POST) for example) of hardware. The first processing unit 150 then transmits, to the service processor 10, a status notification indicating that the processing to be executed prior to activating an OS has been completed.

The second processing unit 160 stops processing and waits until an OS activation request is received from the service processor 10 (step S73). The second processing unit 160 then receives, from the service processor 10, an OS acquisition request including data indicating the status of the disk boot node 100 (step S75).

The second processing unit 160 acquires system data from the disk boot node 100 (step S77), and activates the OS using the data used for OS activation included in the system data acquired (step S79). The second processing unit 160 then activates a network server program included in the system data acquired in step S77 (step S81). The processing then finishes.

When processing such as the above is executed, it becomes possible for the network boot nodes 101 to 103 to perform processing to be executed prior to OS activation, in parallel with the disk boot node 100, and it therefore becomes possible to shorten the time desired for the activation of the system.

Embodiments of the present technology have been described above; however, the present technology is not restricted to these. For example, the functional block configurations of the service processor 10, the disk boot node 100, and the network boot nodes 101 to 103 described may not conform to actual program module configurations.

Furthermore, the configuration of the table described above is an example, and does not have to be a configuration such as the aforementioned. In addition, in the processing flows, it is possible for the sequence of the processing to be altered as long as the processing result does not change. In addition, processing may be executed in parallel.

Furthermore, in the examples mentioned above, the service processor 10 waits until data is received in step S3 and step S53; however, the service processor 10 may independently acquire data without waiting.

When the embodiments of the present technology mentioned above are summarized, the following is constituted.

An information processing system according to a first mode of the embodiments includes: (A) a first node that manages data used for activation of an operating system; (B) a second node that acquires, from the first node via a network, the data used for activation of the operating system, and activates the operating system; and (C) a management device that manages the first node and the second node. The management device mentioned above includes: (c1) a first processing unit that initiates activation for the first node and the second node; (c2) a second processing unit that acquires, from the first node, data indicating the status of the first node; and (c3) a third processing unit that, when the acquired data indicating the status of the first node indicates that activation of the operating system in the first node has been completed, transmits, to the second node, an activation request that requests activation of the operating system in the second node.

In this way, it becomes possible for the first node and the second node to perform, at the same time, processing to be executed prior to activating the operating system, and it therefore becomes possible to shorten the time desired for the activation of the information processing system.

Furthermore, the second node mentioned above may include: (b1) a fourth processing unit that executes processing to be executed prior to activating the operating system; and (b2) a fifth processing unit that stops processing until an activation request is received from the management device, and, when an activation request is received from the management device, acquires, from the first node, data used for activation of the operating system, and activates the operating system in the second node. In this way, the second node does not communicate with the first node until an activation request is received, and an unnecessary communication load is therefore avoided.

Furthermore, the first node mentioned above may include: (a1) a sixth processing unit that executes the processing to be executed prior to activating the operating system; and (a2) a seventh processing unit that activates the operating system. In this way, it is possible appropriately activate the first node.

An information processing system according to a second mode of the embodiments includes: (D) a first node that manages data used for activation of an operating system; (E) a second node that acquires, from the first node via a network, the data used for activation of the operating system, and activates the operating system; and (F) a management device that manages the first node and the second node. The management device mentioned above includes: (f1) a first processing unit that initiates activation for the first node and the second node; (f2) a second processing unit that acquires, from the first node, data indicating the status of the first node; and (f3) a third processing unit that, when a first request that requests the data indicating the status of the first node is received from the second node, transmits the data indicating the status of the first node to the second node. Furthermore, the second node mentioned above includes: (e1) a fourth processing unit that, when the data indicating the status of the first node received from the management device indicates that activation of the operating system in the first node has been completed, acquires, from the first node, data used for activation of the operating system, and activates the operating system in the second node.

In this way, it becomes possible for the first node and the second node to perform, at the same time, processing to be executed prior to activating the operating system, and it therefore becomes possible to shorten the time desired for the activation of the information processing system.

A control method for an information processing system according to a third mode of the embodiments is a control method for an information processing system that includes: a first node that manages data used for activation of an operating system; a second node that acquires, from the first node via a network, the data used for activation of the operating system, and activates the operating system; and a management device that manages the first node and the second node. The control method includes processing in which a processor of the management device: (G) initiates activation for the first node and the second node; (H) acquires, from the first node, data indicating the status of the first node; and, (I) when the acquired data indicating the status of the first node indicates that activation of the operating system in the first node has been completed, transmits, to the second node, an activation request that requests activation of the operating system in the second node.

A control method for an information processing system according to a fourth mode of the embodiments is a control method for an information processing system that includes: a first node that manages data used for activation of an operating system; a second node that acquires, from the first node via a network, the data used for activation of the operating system, and activates the operating system; and a management device that manages the first node and the second node. The control method includes processing in which a processor of the management device: (J) initiates activation for the first node and the second node; (K) acquires, from the first node, data indicating the status of the first node; and, (L) when a first request that requests the data indicating the status of the first node is received from the second node, transmits the data indicating the status of the first node to the second node.

Furthermore, it is possible to create a program for causing a processor to perform processing according to the aforementioned method, with the program being stored in a computer-readable storage medium or storage device such as a flexible disk, a CD-ROM, a magneto-optical disk, a semiconductor memory, or a hard disk. Moreover, an intermediate processing result may be temporarily stored in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a first node configured to manage data used for activation of an operating system;
a second node configured:
to acquire, from the first node via a network, the data used for activation of the operating system, and
to activate the operating system; and
a management device configured to manage the first and second nodes, wherein
the management device includes:
a first processing unit configured to initiate activation for the first and second nodes;
a second processing unit configured to acquire, from the first node, status data indicating a status of the first node; and
a third processing unit configured to, upon receiving a status request that requests the status data, from the second node, transmit the status data to the second node; and
the second node includes:
a fourth processing unit configured:
to acquire, from the first node, data used for activation of the operating system when the status data received from the management device indicates that activation of the operating system for the first node has been completed, and
to activate the operating system for the second node.

2. The information processing system of claim 1, wherein
the third processing unit of the management device transmits, to the second node, an activation request that requests activation of the operating system for the second node when the acquired status data indicates that activation of the operating system for the first node has been completed.

3. The information processing system of claim 2, wherein
the second node further includes a fifth processing unit configured to execute processing to be executed prior to activating the operating system; and
the fourth processing unit stops processing until the activation request is received from the management device; and
when the activation request is received from the management device, the fourth processing unit acquires, from the first node, data used for activation of the operating system, and activates the operating system for the second node.

4. The information processing system of claim 1, wherein
the first node includes:
a sixth processing unit configured to execute the processing to be executed prior to activating the operating system; and
a seventh processing unit configured to activate the operating system.

5. An method for managing first and second nodes in an information processing system, the first node being configured to manage data used for activation of an operating system, the second node being configured to activate the operating system by acquiring, from the first node via a network, the data used for activation of the operating system, the method comprising:
initiating activation for the first and second nodes;
acquiring, from the first node, status data indicating a status of the first node; and
when a status request that requests the status data is received from the second node, transmitting the status data to the second node.

6. A non-transitory, computer-readable recording medium having stored therein a program for causing a processor of a management device to execute a process, the management device being configured to manage first and second nodes, the first node being configured to manage data used for activation of an operating system, the second node being configured to activate the operating system by acquiring, from the first node via a network, the data used for activation of the operating system, the process comprising:
initiating activation for the first and second nodes;
acquiring, from the first node, status data indicating a status of the first node; and
when a status request that requests the status data is received from the second node, transmitting the status data to the second node.
